(19) United States
(12) Patent Application Publication
(10) Pub. No.: US 2007/0211598 A1
(43) Pub. Date: Sep. 13, 2007

(54) Optical disc apparatus

(75) Inventors: Tsuyoshi Eiza, Osaka (JP); Shinya Shimizu, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/712,488

(22) Filed: Mar. 1, 2007

(30) Foreign Application Priority Data
Mar. 2, 2006 (JP) 2006-056318

(51) Int. Cl. G11B 7/00

(52) U.S. Cl. 369/112.02

(57) ABSTRACT

A liquid crystal element control portion of an optical disc apparatus includes a memory for storing first information concerning a relationship between a drive voltage to be applied to a liquid crystal element when an optimal reproduced signal is obtained and ambient temperature of the liquid crystal element and second information concerning a relationship between a response time characteristic of the liquid crystal element and temperature, a drive voltage obtaining portion for measuring a response time of the liquid crystal element at a predetermined timing and obtaining a drive voltage to be applied to the liquid crystal element in which an influence of temperature variation is corrected based on the obtained response time and the first and the second information, and a liquid crystal element driving circuit for driving the liquid crystal element at the drive voltage obtained by the drive voltage obtaining portion.

This application is based on Japanese Patent Application No. 2006-056318 filed on Mar. 2, 2006, the contents of which are hereby incorporated by reference.

### BACKGROUND OF THE INVENTION

1. Field of the Invention

The present invention relates to an optical disc apparatus that is used for recording and reproducing information on an optical recording medium. In particular, the present invention relates to a technique for stabilizing quality in recording and reproducing information by the optical disc apparatus equipped with a liquid crystal element.

2. Description of Related Art

Optical recording media including a compact disc (hereinafter referred to as a CD) and a digital versatile disc (hereinafter referred to as a DVD) are widely available. Furthermore, in order to increase a quantity of information recorded on the optical recording medium, researches on the high density of the optical recording medium are being carried on in recent years. For example, a high density optical recording medium such as a Blu-Ray Disc (hereinafter referred to as a BD) is being available in the market. Therefore, many optical disc apparatuses that can record and reproduce information on a plurality of types of optical recording media have been developed recently.

A thickness of a protective layer that protects a recording surface of the optical recording medium depends on a type of the optical recording medium. For example, thickness values of the protective layer of a CD, a DVD and a BD are 1.2 mm, 0.6 mm and 0.1 mm, respectively. Furthermore, the optical disc apparatus that supports a plurality of types of optical recording media may have a problem of deterioration of quality in recording and reproducing information, which is caused by spherical aberration generated by the difference of the protective layer among the types of the optical recording media. Therefore, there is an optical disc apparatus proposed conventionally, which has a liquid crystal element disposed in an optical system of an optical pickup provided to the optical disc apparatus, and a voltage that is applied to the liquid crystal element is controlled so that a phase of a light beam that passes through the liquid crystal element is controlled for correcting the spherical aberration.

In addition, the purpose of disposing the liquid crystal element in the optical system of the optical pickup is not limited to correction of the spherical aberration as described above, but there is another purpose of correcting coma aberration that is generated when an optical axis of the light beam emitted from the light source is inclined with respect to the recording surface of the optical recording medium, by controlling a drive voltage to be applied to the liquid crystal element, as described in JP-A-2000-298862, for example.

The liquid crystal element that is used in the optical disc apparatus for the purpose of correcting wave aberration such as spherical aberration or coma aberration as described above is known to have characteristics that vary along with temperature change. For this reason, if correction of characteristics variation due to temperature change of the liquid crystal element is not considered, there will be a problem of deterioration of quality in recording and reproducing information by the optical disc apparatus, because the liquid crystal element cannot correct the wave aberration such as spherical aberration or coma aberration sufficiently.

Concerning this point, JP-A-2000-298862 or JP-A-2000-40249 for example describes a technique, in which an optical disc apparatus that is provided with a liquid crystal element includes a temperature sensor such as a thermistor disposed in the optical disc apparatus so as not to be affected by characteristics variation of the liquid crystal element due to temperature change, and a voltage for driving the liquid crystal element is controlled by using ambient temperature of the liquid crystal element sensed by the temperature sensor and a data about phase characteristics and response characteristics to temperature variation of the liquid crystal that is stored in advance in a memory or the like provided to the optical disc apparatus.

However, since the optical disc apparatus described in JP-A-2000-298862 or JP-A-2000-40249 has a structure in which a voltage to be applied to the liquid crystal element is controlled in response to temperature change by disposing a temperature sensor separately in the apparatus for sensing ambient temperature of the liquid crystal element, there is a problem of increasing number of components, complicated structure of the apparatus and increase of manufacturing cost when manufacturing the optical disc apparatus.

### SUMMARY OF THE INVENTION

In view of the above described problem, it is an object of the present invention to provide an optical disc apparatus having a liquid crystal element for a purpose of correcting wave aberration, which can correct appropriately an influence of characteristics variation of the liquid crystal element due to temperature change without disposing a temperature sensor separately in the apparatus for sensing ambient temperature of the liquid crystal element.

To attain the above described object, an optical disc apparatus in accordance with one aspect of the present invention includes: an optical pickup including a light source, a light detecting portion for receiving a light beam so as to convert light information of the light beam into an electric signal, an optical system for condensing the light beam emitted from the light source onto a recording surface of an optical recording medium and leading reflection light reflected by the recording surface to the light detecting portion, and a liquid crystal element disposed in the optical system for correcting wave aberration; a liquid crystal element driving circuit for driving the liquid crystal element by applying a voltage to the liquid crystal element; a storage portion for storing in advance first information concerning a relationship between a drive voltage for driving the liquid crystal element in a case where an optimal reproduced signal is obtained by processing the electric signal converted in the light detecting portion and ambient temperature of the liquid crystal element, and second information concerning a relationship between the characteristics or a control value for controlling the characteristics and temperature of a temperature depending component whose characteristics have temperature dependency among components disposed in the apparatus; and a drive voltage obtaining portion for obtaining the characteristics or the control value of the temperature depending component at a predetermined timing, obtaining ambient temperature of the liquid crystal element from the obtained characteristics or the control value and the second information, and obtaining the drive voltage that is supplied to the liquid crystal element driving circuit by using the temperature and the first information.

In addition, according to another aspect of the present invention, in the optical disc apparatus having the structure described above, the temperature depending component is a member that is provided to the optical pickup.

In addition, according to still another aspect of the present invention, in the optical disc apparatus having the structure described above, the temperature depending component is the liquid crystal element, the second information is information concerning a relationship between a response time that is a period of time from application of a predetermined drive voltage to the liquid crystal element until a value of a predetermined signal obtained from the electric signal converted by the light detecting portion becomes substantially constant and ambient temperature of the liquid crystal element, and the drive voltage obtaining portion measures the response time by applying the predetermined drive voltage to the liquid crystal element and obtains ambient temperature of the liquid crystal element by using the obtained response time and the second information.

In addition, according to other aspect of the present invention, in the optical disc apparatus having the structure described above, the temperature depending component is a semiconductor laser that is the light source, the second information is information concerning drive current when light output power of the semiconductor laser is a predetermined value and temperature, and the drive voltage obtaining portion obtains the drive current at the predetermined timing and obtains ambient temperature of the liquid crystal element by using the obtained drive current and the second information.

According to the first structure of the present invention, it is possible to perform appropriately correction of a drive voltage to be applied to the liquid crystal element with respect to temperature variation without providing a temperature sensor such as a thermistor separately. Thus, an optical disc apparatus that can form an appropriate light spot on the recording surface of the optical recording medium regardless of temperature change can be manufactured at low cost, and furthermore the structure of the apparatus itself can be simplified.

In addition, according to a second structure of the present invention, in the optical disc apparatus having the first structure described above, the temperature depending component that is used for obtaining ambient temperature of the liquid crystal element is a member that is provided to the optical pickup. Therefore, a relative distance between the liquid crystal element and the temperature depending component is not so large that the correction of the drive voltage to be applied to the liquid crystal element can be performed appropriately with respect to temperature change around the liquid crystal element.

In addition, according to the third structure of the present invention, in the optical disc apparatus having the second structure described above, the drive voltage to be applied to the liquid crystal element is controlled by using the liquid crystal element itself that is affected by temperature change, so the correction of the drive voltage to be applied to the liquid crystal element can be performed more appropriately with respect to temperature change.

In addition, according to the fourth structure of the present invention, in the optical disc apparatus having the second structure described above, light output power of the semiconductor laser having temperature dependency is conventionally controlled to be constant regardless of ambient temperature variation by using a light receiving element for a front monitor. Therefore, it is possible to realize a structure easily in which ambient temperature of the liquid crystal element can be obtained by utilizing a relationship between drive current for driving the semiconductor laser and temperature without disposing a temperature sensor separately.

### BRIEF DESCRIPTION OF THE DRAWINGS

FIG. 1 is a block diagram to show a structure of an optical disc apparatus according to a first embodiment of the present invention.

FIG. 2 is a schematic diagram of an optical system of an optical pickup that is provided to an optical disc apparatus shown in FIG. 1.

FIGS. 3A and 3B are explanatory diagrams for describing a structure of the liquid crystal element that is provided to the optical disc apparatus shown in FIG. 1; FIG. 3A is a schematic cross sectional view thereof, and FIG. 3B is a plan view thereof.

FIG. 4 is a graph to show spherical aberration and a pattern of a phase difference that is generated in the liquid crystal element for correcting the spherical aberration.

FIG. 5 is a block diagram to show a structure of a liquid crystal element control portion of the optical disc apparatus shown in FIG. 1.

FIG. 6 is a diagram to show schematically a relationship between a phase variation that is generated in the liquid crystal element and time when a predetermined drive voltage is applied to the liquid crystal element.

FIG. 7 is a diagram to show a relationship between ambient temperature of the liquid crystal element and response time of the liquid crystal element.

FIG. 8 is a flowchart to show a control method of the drive voltage to be applied to the liquid crystal element performed by the liquid crystal element control portion of the optical disc apparatus shown in FIG. 1.

FIG. 9 is a block diagram to show a structure of an optical disc apparatus according to a second embodiment of the present invention.

FIG. 10 is a block diagram to show a relationship between drive current and light output power of a semiconductor laser at each temperature.

### DETAILED DESCRIPTION OF THE PREFERRED EMBODIMENTS

Now contents of the present invention will be described in detail, but embodiments described here are merely examples, and it should be understood that the present invention is not interpreted to be limited to the embodiments.

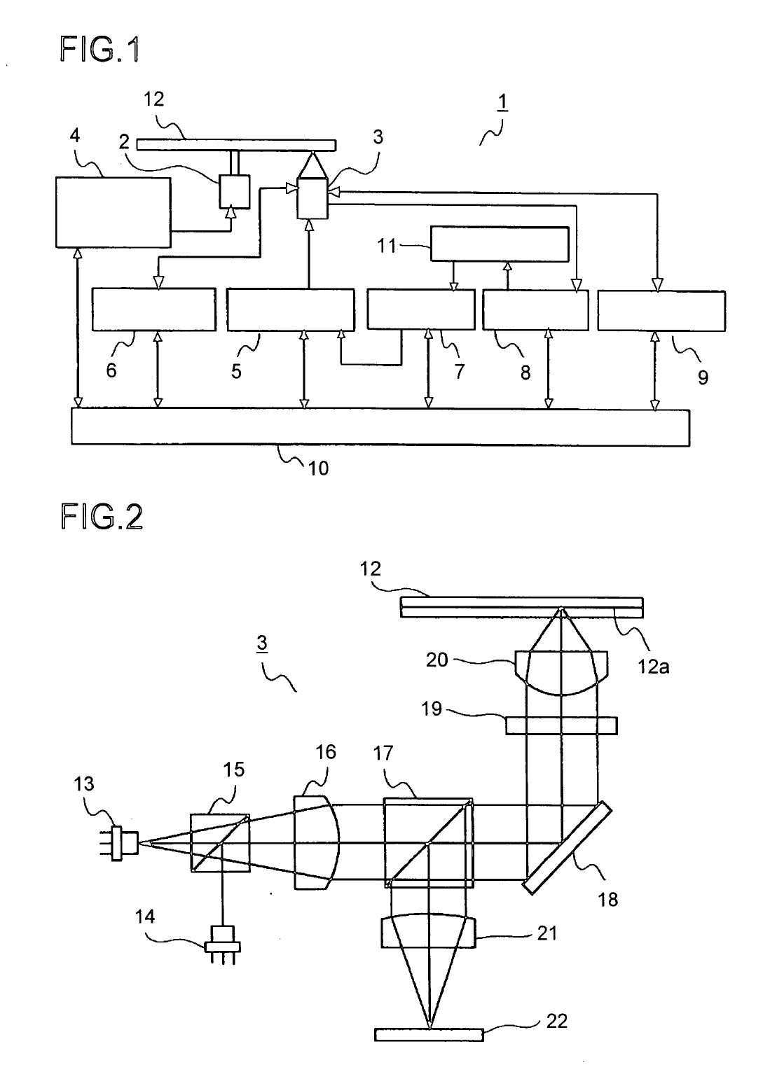

FIG. 1 is a block diagram to show a structure of an optical disc apparatus according to a first embodiment of the present invention. An optical disc apparatus 1 is capable of reproducing information from an optical recording medium 12 and recording information on the optical recording medium 12. Numeral 2 denotes a spindle motor, and the optical recording medium 12 is retained in a removable manner by a chucking portion (not shown) that is disposed at the upper portion of the spindle motor 2. Then, the spindle motor 2 drives the optical recording medium 12 to rotate continuously when information is recorded on or reproduced from the optical recording medium 12. Rotation control of the spindle motor 2 is performed by a spindle motor control portion 4.

Numeral 3 denotes an optical pickup that projects a light beam emitted from the light source onto the optical recording medium 12 so that information can be written on the optical recording medium 12 and that information recorded on the optical recording medium 12 can be read. FIG. 2 is a schematic diagram of an optical system of the optical pickup 3. As shown in FIG. 2, in the optical pickup 3, the light beams emitted from a light sources 13 and 14 are made to have the same optical axis by a color synthesis prism 15 and are made to be parallel rays by a collimator lens 16. Then, the light beam passes through a beam splitter 17, is reflected by an upstand mirror 18 so that its optical axis is substantially perpendicular to a recording surface 12a of the optical recording medium 12, passes through a liquid crystal element 19, and is condensed by an objective lens 20 onto the recording surface 12a of the optical recording medium for recording information.

Reflection light that is reflected by the optical recording medium 12 passes through the objective lens 20 and the liquid crystal element 19 in this order, is reflected by the upstand mirror 18 and is further reflected by the beam splitter 17 so that it is condensed by a condenser lens 21 onto a light receiving portion (not shown) of a photo detector 22. The photo detector 22 converts the received light signal into an electric signal. At this point, the light source 13 in the present embodiment is a two-wavelength integrated laser diode that emits light beams for a CD and for a DVD, while the light source 14 is a laser diode that emits a light beam for a BD. Therefore, the optical disc apparatus 1 is capable of recording and reproducing information on a CD, a DVD and a BD.

The optical pickup 3 can support three different types of optical recording media 12, and these different types of the optical recording media 12 have different thicknesses of the protective layer as described above. Therefore, there is a problem of spherical aberration in the optical pickup 3 that has only one objective lens 20 like the present embodiment. For this reason, a liquid crystal element 19 is disposed so as to correct the spherical aberration.

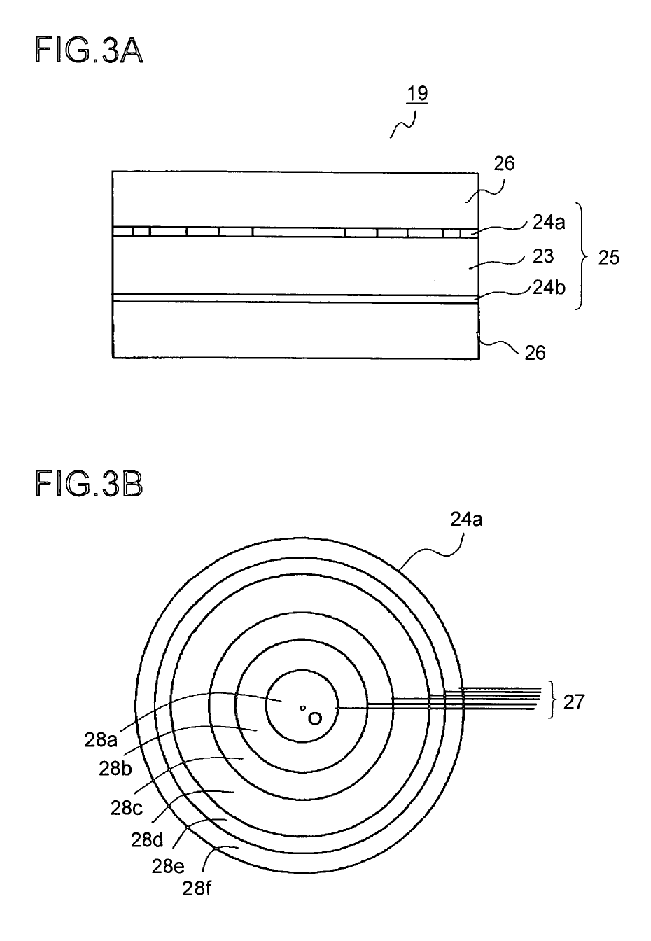

FIGS. 3A and 3B are explanatory diagrams for describing a structure of the liquid crystal element 19 that is provided to the optical pickup 3. FIG. 3A is a schematic cross sectional view to show a structure of the liquid crystal element 19, and FIG. 3B is a plan view of the liquid crystal element 19 shown in FIG. 3A when viewed from the top. As shown in FIG. 3A, the liquid crystal element 19 includes a liquid crystal 23, two transparent electrodes 24a and 24b that sandwich the liquid crystal 23, and two glass plates 26 that sandwich a portion 25 consisting of the liquid crystal 23 and the transparent electrodes 24a and 24b.

As shown in FIG. 3B, the transparent electrode 24a that constitutes the liquid crystal element 19 is divided into a plurality of concentric circular areas 28a-28f. On the other hand, the transparent electrode 24b that is opposed to the transparent electrode 24a is not divided but forms a single common electrode as a whole. At this point, it is possible to form the transparent electrode 24b as a plurality of concentric circular areas in the same manner as the transparent electrode 24a. Such a structure of the transparent electrodes 24a and 24b enables the light beam that passes through the liquid crystal element 19 to generate a desired phase difference, so that spherical aberration that is generated when reproducing or recording information on various types of optical recording media 12 can be corrected appropriately. At this point, the transparent electrodes 24a and 24b are connected electrically via lead wires 27 to a liquid crystal element driving circuit of a liquid crystal element control portion 9 that will be described later, and that the liquid crystal element control portion 9 controls a drive voltage to be applied to the transparent electrodes 24a and 24b.

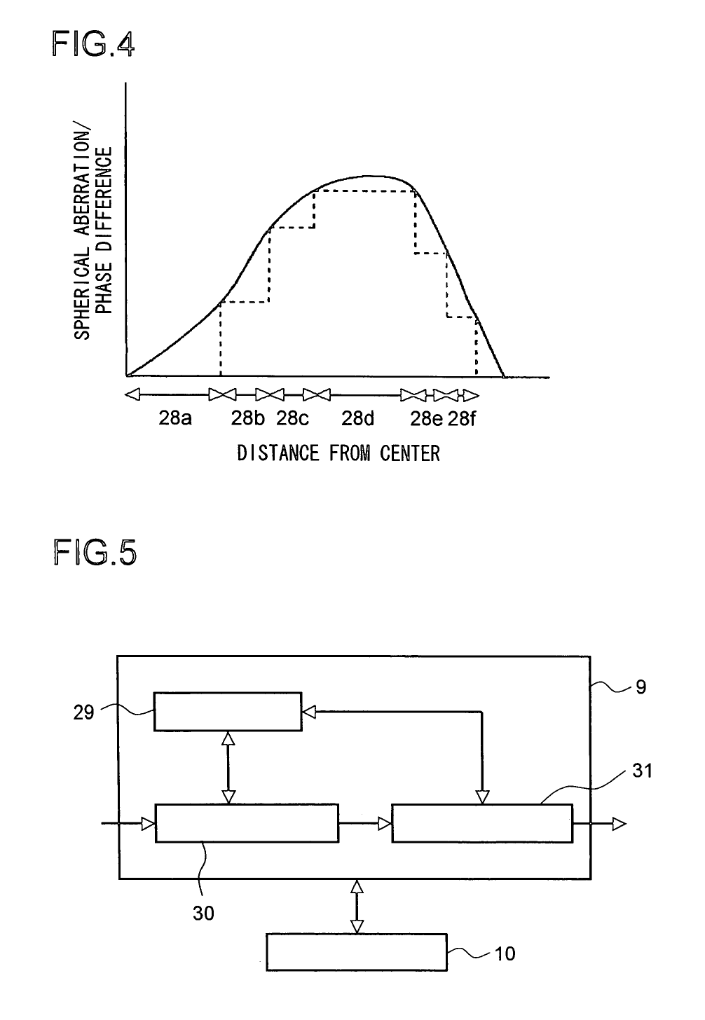

Actions of the liquid crystal element 19 having the structure described above will be described below. FIG. 4 is a graph to show spherical aberration (a solid line in the graph) that is generated when information is reproduced or recorded on a certain optical recording medium 12 and a pattern of a phase difference (a broken line in the graph) that is generated by the liquid crystal element 19 for correcting the spherical aberration. At this point, the phase difference pattern to be generated by the liquid crystal element 19 must have the opposite phase to the phase difference pattern shown in FIG. 4 so as to cancel the spherical aberration, but the pattern shown in FIG. 4 is not the opposite phase as a matter of convenience. In addition, the horizontal axis in FIG. 4 indicates a distance from the center 0 of the transparent electrode 24a that is divided into concentric circular areas, and the numbers indicated below the horizontal axis correspond to numerals that denote the areas of the transparent electrode 24a (see FIG. 3B).

When a voltage is applied to the transparent electrodes 24a and 24b so that the areas 28a-28f generate the phase difference pattern that has the opposite phase to the phase difference pattern shown in FIG. 4 (the broken line in the graph), aberration is corrected to be a level that becomes almost trivial for reproducing or recording information on the optical recording medium 12 so that an appropriate reproduced signal can be obtained. At this point, generation quantity of the spherical aberration depends on a type of the optical recording medium 12, so the phase difference to be generated by the liquid crystal element 19 as well as a value of voltage to be applied to the transparent electrodes 24a and 24b should be different in accordance with a type of the optical recording medium 12.

With reference to FIG. 1 again, the optical disc apparatus 1 is equipped with a laser control portion 5, a servo control portion 6, a record control portion 7, a reproduction control portion 8 and the liquid crystal element control portion 9. At this point, these control portions 5-9 and the spindle motor control portion 4 described above are connected to a system control portion 10 that controls the whole system. Hereinafter, each of the control portions 5-9 will be described.

The laser control portion 5 controls output power of the laser beam emitted from the semiconductor lasers that are light sources 13 and 14 (see FIG. 2) provided to the optical pickup 3. In addition, the laser control portion 5 is connected to the record control portion 7, and operation thereof is controlled by a signal from the record control portion 7. The record control portion 7 will be described later.

The servo control portion 6 performs servo control such as focusing control and tracking control in the optical pickup 3. The servo control portion 6 generates a focus error signal and a tracking error signal based on the electric signal obtained by the photo detector 22 (see FIG. 2) and supplies a drive signal to an actuator (not shown) that includes the liquid crystal element 19 and the objective lens 20 (see FIG. 2 for both) and is provided to the optical pickup 3. The actuator that is provided with the drive signal operates each of the portions based on the signal so as to perform the focusing control for adjusting focus by moving the objective lens 20 in the direction parallel with the optical axis and the tracking control for making a position of a light beam spot match a position of a track formed on the optical recording medium 12 by moving the objective lens 20 in a radial direction of the optical recording medium 12.

The record control portion 7 plays a role of modulating information data entered from an external device (not shown) such as a personal computer via an interface 11, by using a modulation circuit (not shown) and a role of transmitting the modulated data signal to the laser control portion 5.

The reproduction control portion 8 generates a reproduced signal by using the electric signal detected by the photo detector 22 that is provided to the optical pickup 3. Then, the generated reproduced signal is sent to an external device such as a personal computer via the interface 11.

The liquid crystal element control portion 9 plays a role of controlling the drive voltage to be applied to the transparent electrodes 24a and 24b of the liquid crystal element 19 that is provided to the optical pickup 3. Since the spherical aberration is different among various types of the optical recording media 12 as described above, a data of voltages to be applied to the transparent electrodes 24a and 24b for various types of optical recording media 12 (a CD, a DVD and a BD) are stored in a memory (not shown) that is provided to the liquid crystal element control portion 9. Then, the optical disc apparatus 1 of the present embodiment is structured so that the drive voltage after correcting characteristics variation due to temperature change of the liquid crystal element 19 is applied to the liquid crystal element 19. Hereinafter, the structure of the correction of the drive voltage to be applied to the liquid crystal element 19 with respect to temperature change will be described.

FIG. 5 is a block diagram to show a structure of the liquid crystal element control portion 9. The liquid crystal element control portion 9 is equipped with a memory (storage portion) 29, a drive voltage obtaining portion 30, and a liquid crystal element driving circuit 31. The memory 29 stores first information concerning a relationship between the drive voltages to be applied to the liquid crystal element 19 for optimizing the reproduced signal for various types of optical recording media 12 and ambient temperature of the liquid crystal element 19.

This first information is generated by changing ambient temperature of the liquid crystal element 19 at a predetermined temperature interval so as to measure the drive voltage to be applied to the liquid crystal element 19 in a case where a jitter becomes the minimum value, which is generated based on an electric signal obtained from the photo detector 22 (see FIG. 2) for example, with respect to each temperature, and by organizing the measurement result into a table. In a case of the present embodiment, the transparent electrode 24a that forms the liquid crystal element 19 is divided into a plurality of concentric circular areas 28a-28f (see FIG. 3B), so the drive voltage to be applied to each of the areas 28a-28f is stored with respect to each temperature.

At this point, since the drive voltage to be applied to the liquid crystal element 19 in a case where jitter becomes the minimum value is different among various types of the optical recording media 12, the table is generated for each of the various types of the optical recording media 12. Furthermore, when the first information stored in the memory 29 is obtained in the present embodiment, the case where the jitter that is generated based on the signal obtained by the photo detector 22 becomes the minimum value is used as an indicator of an optimal reproduced signal for deciding the drive voltage to be applied to the liquid crystal element 19, but the present invention should not be limited to this structure. It is possible to use amplitude of a tracking error (Te) signal or an RF signal obtained by processing an electric signal obtained by the photo detector 22 as the indicator for deciding the drive voltage to be applied to the liquid crystal element 19. At this point, in these cases the reproduced signal becomes optimal when the amplitude of the RF signal or the Te signal becomes a maximum value.

In addition, the first information concerning a relationship between ambient temperature of the liquid crystal element 19 and the drive voltage to be applied to the liquid crystal element 19 at each temperature is organized into a table that is stored in the memory 29 in the present embodiment, but the present invention should not be limited to this structure. For example, it is possible to adopt a structure in which if a specific relational expression is obtained as the relationship between ambient temperature of the liquid crystal element 19 and the drive voltage, the relational expression is stored in the memory 29 as the first information.

The memory 29 stores not only the first information but also second information concerning a relationship between the ambient temperature of the liquid crystal element 19 and a response time that is a time from the application of the predetermined drive voltage to the liquid crystal element 19 until a value of the jitter generated from the electric signal obtained by the photo detector 22 becomes substantially a constant value. Hiereinafter, this second information will be further described.

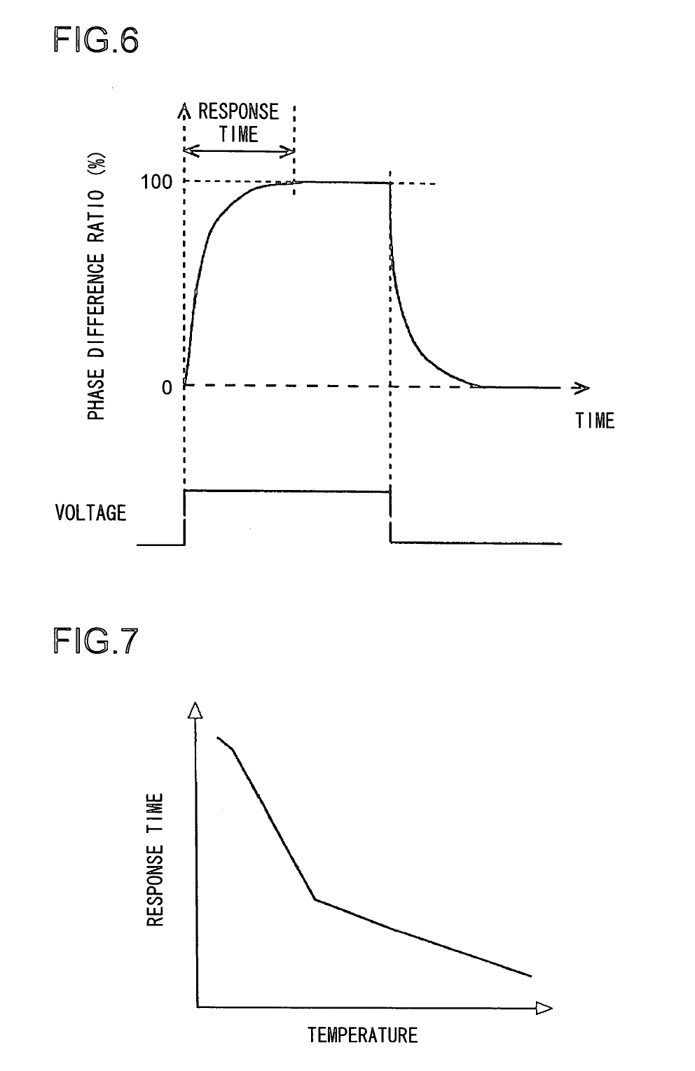

FIG. 6 is a diagram to show schematically a relationship between a phase variation that is generated in the liquid crystal element 19 and time when a predetermined drive voltage is applied to the liquid crystal element 19, in which the horizontal axis represents time while the vertical axis represents a phase variation ratio. As understood from FIG. 6, a certain length of time is required as a period from application of a predetermined drive voltage to the liquid crystal element 19 until the phase variation becomes 100%. The time period until the phase variation becomes 100% in this case is the response time of the liquid crystal element 19. FIG. 7 is a diagram to show a relationship between ambient temperature of the liquid crystal element 19 and the response time of the liquid crystal element 19, and it is understood that the response time is also varied in accordance with the characteristics variation due to the temperature change of the liquid crystal element 19.

There are various measurement methods for measuring the response time of the liquid crystal element 19. In the present embodiment, a time period from the application of the predetermined drive voltage to the liquid crystal element 19 until a value of the jitter generated from the electric signal obtained by the photo detector 22 becomes substantially a constant value is regarded as the response time. Then, the ambient temperature of the liquid crystal element 19 is changed at a predetermined temperature interval so as to measure the response time at each temperature, and the relationship between this response time and the ambient temperature of the liquid crystal element is organized into a table, which is to be the second information.

At this point, although the second information is generated in the present embodiment by obtaining the response time from the measurement of jitter, the present invention should not be limited to this structure. It is possible to adopt a structure in which the response time is obtained by measurement of the RF signal or the Te signal. In addition, although the second information concerning the relationship between the ambient temperature of the liquid crystal element 19 and the response time is organized into a table that is stored in the present embodiment, the present invention should not be limited to this structure. It is possible to adopt a structure, for example, in which if a specific relational expression is obtained as the relationship between apparatus temperature and the response time, the relational expression is stored in the memory 29 as the second information.

The drive voltage obtaining portion 30 receives the electric signal from the photo detector 22 and transmits the electric signal to the liquid crystal element driving circuit 31. The drive voltage obtaining portion 30 further performs transmission and reception of information with the memory 29 too. The drive voltage obtaining portion 30 is structured to obtain a jitter value of the optical disc apparatus 1 from the electric signal obtained by the photo detector 22. Then, the drive voltage obtaining portion 30 starts to measure the jitter every predetermined time period. At that time, it obtains the drive voltage to be applied to the liquid crystal element 19 every predetermined time, by using the response time obtained by measuring the response time of the liquid crystal element 19 that is the time period until the jitter value becomes substantially a constant value and the first information and the second information stored in the memory 29.

The liquid crystal element driving circuit 31 is connected to the transparent electrodes 24a and 24b (see FIG. 3A) that constitutes the liquid crystal element 19 for controlling the drive voltage of the liquid crystal element 19. More specifically, the liquid crystal element driving circuit 31 receives information from the drive voltage obtaining portion 30 and applies the drive voltage to the liquid crystal element 19 considering the characteristics variation due to the temperature change of the liquid crystal element 19.

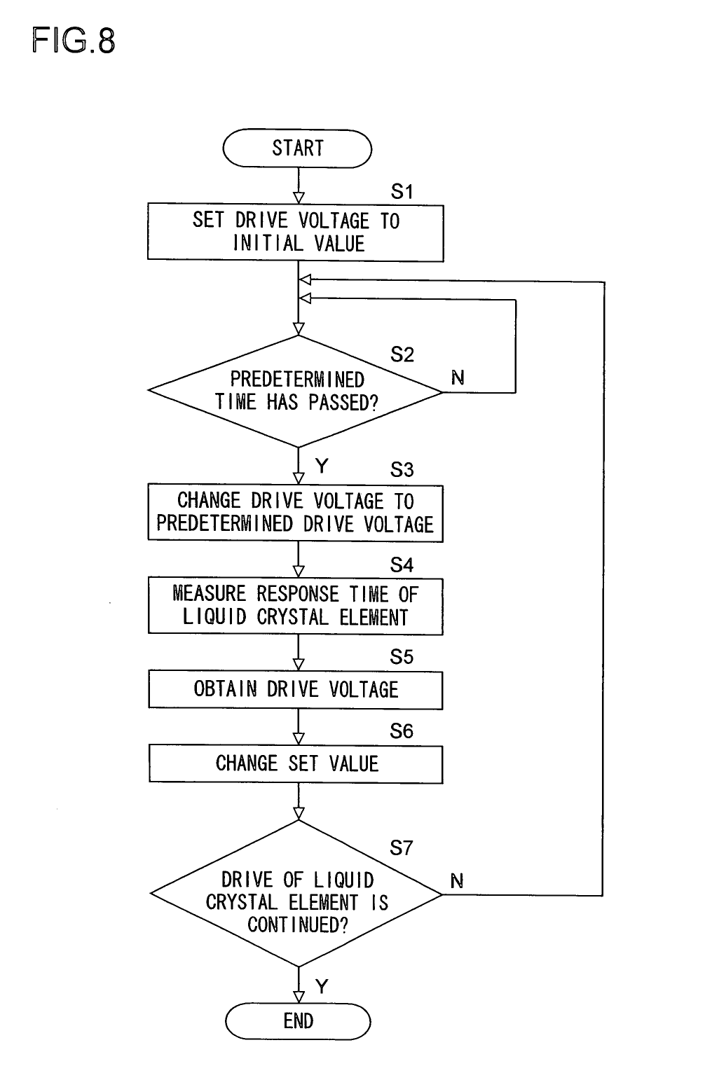

Control of the drive voltage of the liquid crystal element 19 performed by the liquid crystal element control portion 9 having the structure described above will be described with reference to a flowchart shown in FIG. 8. The drive voltage to be applied to the liquid crystal element 19 is set to an initial value that is a predetermined value just after activating the optical disc apparatus 1 (Step S1). After that, the drive voltage obtaining portion 30 checks whether or not a predetermined time has passed (Step S2). If the predetermined time has passed, the liquid crystal element driving circuit 31 changes the drive voltage to be applied to the liquid crystal element 19 to a predetermined drive voltage for correcting it to be a drive voltage corresponding to temperature change (Step S3). On the other hand, if the predetermined time has not passed, the drive voltage of the liquid crystal element 19 is not changed until the predetermined time passes.

When the liquid crystal element 19 is supplied with the predetermined drive voltage, the drive voltage obtaining portion 30 starts the measurement of the jitter and measures the time period until the measurement value of the jitter becomes substantially a constant value, which is regarded as the response time of the liquid crystal element 19 (Step S4). When the drive voltage obtaining portion 30 obtains the response time of the liquid crystal element 19, it determines the ambient temperature of the liquid crystal element 19 from the obtained response time and the second information stored in the memory 29, and it further obtains the drive voltage to be applied to the liquid crystal element 19 for the reproduced signal to be optimal at the temperature from the first information stored in the memory 29 (Step S5). The information as to the drive voltage obtained by the drive voltage obtaining portion 30 is sent to the liquid crystal element driving circuit 31, and the liquid crystal element driving circuit 31 changes the drive voltage to a drive voltage value obtained in the step S5 (Step S6).

After that, it is checked whether or not the drive of the liquid crystal element 19 is continued (Step S7). If the drive of the liquid crystal element 19 is continued, the process goes back to the step S2 so that the process of the steps S2 to S7 is repeated. On the contrary, if the drive of the liquid crystal element 19 is to be finished, the liquid crystal element control portion 9 finishes the control of the liquid crystal element 19.

Although the drive voltage obtaining portion 30 performs the correction of the drive voltage to be applied to the liquid crystal element 19 every predetermined time in the present embodiment, the present invention should not be interpreted to be limited to this structure. For example, it is possible to adopt another structure in which it performs the correction of the drive voltage to be applied to the liquid crystal element 19 every event such as when the apparatus is activated, or before information is recorded or reproduced, or when quality of record or reproduction becomes lower than a predetermined standard level.

Furthermore, in the present embodiment, it is noted that the response time of the liquid crystal element 19 has temperature dependency, and a relationship between the response time and temperature of the liquid crystal element 19 is used for obtaining ambient temperature of the liquid crystal element 19, so that the drive voltage of the liquid crystal element 19 is corrected based on the obtained temperature, but the present invention should not be interpreted to be limited to this structure. The structure can be modified variously within the spirit and the scope of the present invention without deviating from it. For example, it is possible to adopt another structure in which a temperature depending component having characteristics of temperature dependency is disposed in the vicinity of the liquid crystal element 19 and is used instead of the liquid crystal element 19. As such a structure, for example, there is a structure in which ambient temperature of the liquid crystal element 19 is obtained by utilizing temperature dependency of the light sources 13 and 14 (see FIG. 2) made up of a semiconductor laser.

At this point, it is preferable in this case that the temperature depending component is a member that can be disposed at a position not too far from the liquid crystal element 19 for obtaining the ambient temperature of the liquid crystal element 19 correctly, so that the component is a member provided to the optical pickup 3, for example.

Hereinafter, an optical disc apparatus 51 that is a second embodiment will be described, in which ambient temperature of the liquid crystal element 19 is obtained by utilizing temperature dependency of a semiconductor laser. At this point, in the following description of the optical disc apparatus 51 as the second embodiment, portions overlapping with the first embodiment are denoted by the same reference numerals, and description thereof will be omitted except a case where description is necessary in particular.

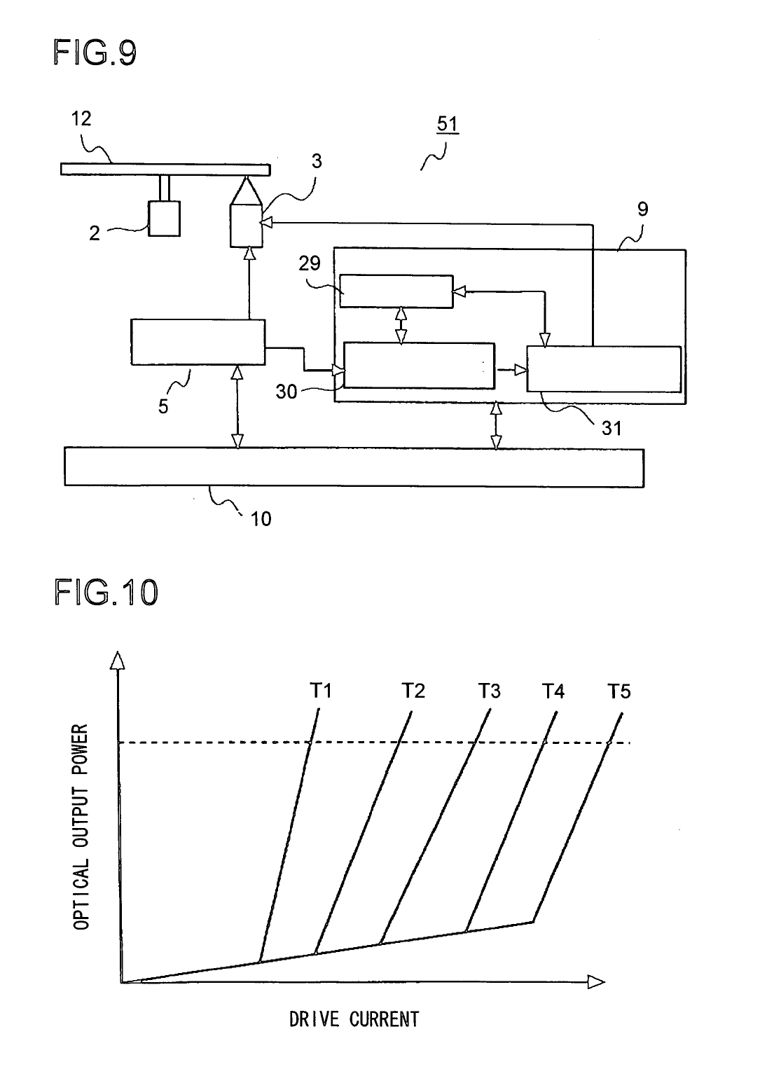

FIG. 9 is a block diagram to show a structure of the optical disc apparatus 51 of the second embodiment. At this point, the spindle motor control portion 4, the servo control portion 6, the record control portion 7 and the reproduction control portion 8 (see FIG. 1 for them) are omitted in FIG. 9 because they have the same structures as in the optical disc apparatus 1 of the first embodiment. The optical disc apparatus 51 is different from the optical disc apparatus 1 of the first embodiment in that the drive voltage obtaining portion 30 provided to the liquid crystal element control portion 9 is connected not to the photo detector 22 (see FIG. 2) but to a laser driving circuit (not shown) provided to the laser control portion 5. Then, in association with this, structures of the second information and the drive voltage obtaining portion 30 that are stored in the memory 29 are also different from the case of the optical disc apparatus 1 of the first embodiment.

FIG. 10 is a diagram to show a relationship between drive current and light output power of a semiconductor laser that is the light source 14 for a BD at each temperature. It is understood from FIG. 10 that the light output power of the semiconductor laser varies in accordance with ambient temperature of the semiconductor laser in a case where the drive current is constant. Considering this point, when the optical disc apparatus 51 performs reproduction or record of information on the optical recording medium 12, the drive current for driving the semiconductor laser is adjusted while detecting light quantity by a light receiving element for a front monitor (not shown) so that it becomes a predetermined light output power (corresponding to a dotted line in FIG. 10).

Therefore, ambient temperature of the semiconductor laser can be obtained when the drive current of the semiconductor laser is measured by obtaining a relationship between the drive current and the temperature in a case of a predetermined light output power for a semiconductor laser that is used as a light source for the optical disc apparatus 51. At this point, the drive current of the semiconductor laser in this case corresponds to a control value for controlling the light output power, which is characteristic unique to the semiconductor laser. Furthermore, since the semiconductor laser (the light source 13 or 14) is disposed at a position relatively close to the liquid crystal element 19 in the optical disc apparatus 51, the ambient temperature of the semiconductor laser can represent the ambient temperature of the liquid crystal element 19. Therefore, as the second information to be stored in the memory 29, a relationship between temperature around the light source (the semiconductor laser) and the drive current of the semiconductor laser is measured in advance and is organized to be a table.

The drive voltage obtaining portion 30 measures the drive current of the semiconductor laser every predetermined time for example, and it obtains the ambient temperature of the liquid crystal element 19 by using the second information stored in the memory 29 in accordance with the obtained drive current and further obtains the drive voltage to be applied to the liquid crystal element 19 from the temperature and the first information in the same manner as in the first embodiment. The drive voltage information obtained by the drive voltage obtaining portion 30 is sent to the liquid crystal element driving circuit 31 so that the drive voltage is changed.

At this point, it is desirable to obtain the relationship between the temperature and the drive current for each light source and to store the information as the second information because different light sources are used for different types of the optical recording media 12 and the light sources have different characteristics. In addition, the second information is stores as a table in the present embodiment. However, if it is possible to express the relationship between the temperature and the drive current of the semiconductor laser by a specific relational expression, the relational expression may be stored in the memory 29 as the second information.

In the optical disc apparatus 1 or 51 of the first and the second embodiments described above, the drive voltage obtained by the drive voltage obtaining portion 30 may be drive voltage information or the like with respect to all the optical recording media 12 that can be read or written by the optical disc apparatus 1 or 51. In addition, types and numbers of the optical recording media 12 that can be read or written by the optical disc apparatus 1 or 51 are not limited to three types including a CD, a DVD and a BD but can be changed within the spirit and the scope of the present invention without deviating from it. For example, the present invention can be applied to an optical disc apparatus that supports an optical recording medium 12 having a plurality of layers of the recording surface, and it is necessary to generate the first information for each of the layers in a case of the optical recording medium having a plurality of layers of the recording surface.

In addition, although the liquid crystal element 19 that is provided to the optical disc apparatus 1 or 51 is a type for correcting spherical aberration in the first and the second embodiments, the present invention can be applied to a liquid crystal element of a type other than the type for correcting spherical aberration. For example, it can be applied to a type in which the liquid crystal element corrects wave aberration such as coma aberration. In addition, although the optical disc apparatus 1 or 51 is capable of recording and reproducing information in the first and the second embodiments, the present invention should not be limited to this structure. For example, the present invention can be applied to an optical disc apparatus or the like that is only capable of reproducing information.

The optical disc apparatus of the present invention can correct the characteristics variation appropriately, which is due to temperature variation of the liquid crystal element that is provided for correcting wave aberration, so quality in recording and reproducing information on an optical recording medium can be stabilized. Furthermore, it is not necessary to provide a temperature sensor separately in the apparatus for correcting characteristics variation with respect to temperature variation of the liquid crystal element, so the apparatus can be manufactured at low cost, and a structure of the apparatus is not complicated.

What is claimed is:

1. An optical disc apparatus comprising:
an optical pickup including a light source, a light detecting portion for receiving a light beam so as to convert light information of the light beam into an electric signal, an optical system for condensing the light beam emitted from the light source onto a recording surface of an optical recording medium and leading reflection light reflected by the recording surface to the light detecting portion, and a liquid crystal element disposed in the optical system for correcting wave aberration;
a liquid crystal element driving circuit for driving the liquid crystal element by applying a voltage to the liquid crystal element;
a storage portion for storing in advance first information concerning a relationship between a drive voltage for driving the liquid crystal element in a case where an optimal reproduced signal is obtained by processing the electric signal converted in the light detecting portion and ambient temperature of the liquid crystal element, and second information concerning a relationship between the characteristics or a control value for controlling the characteristics and temperature of a temperature depending component whose characteristics have temperature dependency among components disposed in the apparatus; and
a drive voltage obtaining portion for obtaining the characteristics or the control value of the temperature depending component at a predetermined timing, obtaining ambient temperature of the liquid crystal element from the obtained characteristics or the control value and the second information, and obtaining the drive voltage that is supplied to the liquid crystal element driving circuit by using the temperature and the first information.

2. The optical disc apparatus according to claim 1, wherein the temperature depending component is a member that is provided to the optical pickup.

3. The optical disc apparatus according to claim 2, wherein the temperature depending component is the liquid crystal element, the second information is information concerning a relationship between a response time that is a period of time from application of a predetermined drive voltage to the liquid crystal element until a value of a predetermined signal obtained from the electric signal converted by the light detecting portion becomes substantially constant and ambient temperature of the liquid crystal element, and the drive voltage obtaining portion measures the response time by applying the predetermined drive voltage to the liquid crystal element and obtains ambient temperature of the liquid crystal element by using the obtained response time and the second information.

4. The optical disc apparatus according to claim 2, wherein the temperature depending component is a semiconductor laser that is the light source, the second information is information concerning drive current when light output power of the semiconductor laser is a predetermined value and temperature, and the drive voltage obtaining portion obtains the drive current at the predetermined timing and obtains ambient temperature of the liquid crystal element by using the obtained drive current and the second information.
